(19) United States
(12) Patent Application Publication
(10) Pub. No.: US 2026/0133105 A1
(43) Pub. Date: May 14, 2026

(54) PORTABLE SYSTEM AND METHOD FOR TESTING HYDROSTATIC PRESSURE IN A PIPE

(71) Applicant: Babak Torabi, Port Coquitlam (CA)

(72) Inventor: Babak Torabi, Port Coquitlam (CA)

(21) Appl. No.: 19/387,472

(22) Filed: Nov. 12, 2025

Related U.S. Application Data
(60) Provisional application No. 63/720,166, filed on Nov. 13, 2024.
(60) Provisional application No. 63/720,170, filed on Nov. 13, 2024.

(51) Int. Cl. G01N 3/12; G01N 3/04

(52) U.S. Cl. CPC G01N 3/12; G01N 3/04

(57) ABSTRACT

Systems, devices, articles and methods for a portable hydrostatic pressure test device including a first plurality of tension beams placed in parallel to each other and a second plurality of tension beams. The first plurality of tension beams in operation are below the pipe. In operation, the second plurality of tension beams are between a respective pair of the first plurality of tension beams and are in sliding engagement with the first plurality of tension beams. The device includes a headstock coupled to the first plurality of tension beams, a first seal coupled to the headstock, a tailstock coupled to the second plurality of tension beams, a second seal coupled to the tailstock, and an inlet coupled to the headstock or the tailstock and disposed inside a seal to transfer fluid to or from the pipe.

### CROSS-REFERENCE TO RELATED APPLICATIONS

This application claims priority to and incorporates by reference U.S. provisional applications: Ser. No. 63/720,166, filed 2024 November 13 and Ser. No. 63/720,170 filed 2024 Nov. 13.

### TECHNICAL FIELD

The disclosure relates to devices, systems, and methods related to the manufacturing of pipes. More specifically, the disclosure relates to hydrostatic pressure test apparatus (e.g., a mobile pipe) to test quality of pipes (e.g., pipes manufactured near site of use). Fiberglass Reinforced Plastic (FRP)) and associated methods.

### BACKGROUND

The purpose of the following description of related art is solely to provide background information pertaining to the relevant field of the disclosure. It should be noted that this section is only to enhance the understanding of the reader with respect to the present disclosure. Therefore, unless otherwise indicated, it should not be assumed that any of the information described in this section qualifies as prior art merely by their inclusion in this section.

Fiberglass pipes, or Fiberglass Reinforced Plastic (FRP) pipes, are composite materials made from a polymer matrix reinforced with glass fibers and other materials. These pipes are known for their strength, low mass, durability, and corrosion resistance, making them suitable for a wide range of applications. Lower mass and lower rotational inertia than traditional metal pipes make the FRP pipes easier to handle and install. Despite their lightweight nature, FRP pipes offer high tensile strength and can withstand significant pressure. FRP pipes are highly resistant to corrosion from water (e.g., fresh, sea, grey, waste), chemicals, seawater, and wastewater making them suitable for use in various applications, including water and wastewater systems, chemical processing, and oil and gas industries.

Another common name for FRP pipes is Glass Reinforced Plastic (GRP). Both terms refer to the same type of composite material, which is made from a polymer matrix reinforced with glass fibers. Examples of the polymer matrix include those made from epoxy, polyester, phenolic, and vinyl resins. FRP pipes may include within the matrix other materials such as fillers, wherein the known fillers include fine aggregates such as silica sand and enhance the stiffness of the pipes.

### SUMMARY

This section is intended to introduce certain objectives and aspects of the present disclosure in a simplified manner. The disclosure relates to a system to make pipes.

A portable hydrostatic pressure test device for use with a pipe, the device including a first plurality of tension beams placed in parallel to each other and a second plurality of tension beams. Each of the first plurality of tension beams has a first end and a second end, and the first plurality of tension beams in operation are below the pipe. And, in operation, the second plurality of tension beams are between a respective pair of the first plurality of tension beams, and are in sliding engagement with the first plurality of tension beams. The device includes a headstock coupled to the first plurality of tension beams nearer the first end, a first seal coupled to the headstock including a first outer periphery, and which in operation faces the second end of the first plurality of tension beams, a tailstock coupled to the second plurality of tension beams, a second seal coupled to the tailstock including a second outer periphery, and which in operation faces the first end of the first plurality of tension beams; and an inlet coupled to the headstock or the tailstock and disposed proximally of the first outer periphery or the second outer periphery.

A method for testing hydrostatic pressure in a pipe under test by a portable pipe tester including a headstock, a tailstock, and a controller. The method includes placing the pipe under test over a plurality of beams and between the headstock and the tailstock, and in response to moving the headstock and the tailstock together, sealing the ends of the pipe under test. The method includes filling the pipe under test with a fluid, pressurizing the fluid in the pipe under test, and recording, by the controller, the hydrostatic pressure of the pipe under test.

This summary does not necessarily describe the entire scope of all aspects. Other aspects, features, and advantages will be apparent to those of ordinary skill in the art upon review of the following description of specific embodiments.

### BRIEF DESCRIPTION OF DRAWINGS

Systems, devices, and methods are described in greater detail herein with reference to the following figures in which:

FIG. 1 is a perspective view of a mobile pipe formation apparatus and hydrostatic pressure test apparatus in transportation configurations.

FIG. 2 is a perspective view of the mobile pipe formation apparatus and hydrostatic pressure test apparatus in deployed configurations.

FIG. 3 is a perspective view of the testing apparatus in deployed configuration.

FIG. 4 is a perspective view of a tailstock frame included in the hydrostatic pressure test apparatus.

FIG. 5 is a section view of the hydrostatic pressure test apparatus along section line 5-5′ shown in FIG. 3.

FIG. 6 is an elevation view of the hydrostatic pressure test apparatus from the nearside shown in FIG. 3.

FIG. 7 is a perspective view of a detail of the hydrostatic pressure test apparatus shown in the previous figures.

FIG. 8 is a perspective view of a detail of the hydrostatic pressure test apparatus.

FIG. 9 is a section view of the hydrostatic pressure test apparatus and a pipe under test from section line 9-9′ shown in FIG. 6.

FIG. 10 is a perspective view of a lift included in the hydrostatic pressure test apparatus.

FIG. 11 illustrates a flow diagram of a method of operation of a hydrostatic pressure test apparatus.

The above-mentioned drawings illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. Also, the embodiments shown in the figures are not to be construed as limiting the invention but only as illustrative examples of an automated method and system according to the inventions illustrated herein to highlight the advantages of the invention.

### DETAILED DESCRIPTION

In the following description, associated drawings, included claims, and other parts of the document, various details are set forth to provide a detailed understanding of the disclosure and embodiments thereof. It will be apparent, however, that the disclosed embodiments may be practiced without these details. Several features described hereafter can each be used independently of one another or with any combination of other features.

While our collective attention may be drawn to other innovations, the applicant appreciates the critical importance of clean water and sanitation to reduce exposure to countless diseases and conditions. Every year, millions of people die from diseases caused by inadequate water supply and sanitation. Indeed, diarrhea is the second leading cause of death in young children. Further, access to clean water is still unevenly distributed and is one of the biggest concerns. Likewise, the improper handling of wastewater (e.g., effluent, sewage) leads to negative outcomes on our environment and health. This happens for many reasons including lack of the correct components, such as pipes. Therefore, industrial processes involving fluid must minimize their impact with proper fluid-handling components.

Transporting FRP pipes is possible but expensive since pipes don't pack well in standard shipping forms. Setting up traditional FRP pipe factories in locations that need improved infrastructure is impractical due to many reasons such as unwieldy apparatus and bad roads especially in underdeveloped regions that face challenges related to water availability, robust roads, and other remote infrastructure.

In view of the above-mentioned problems and challenges, the Applicant appreciates there is a need for mobile systems, devices, and methods to produce FRP pipes.

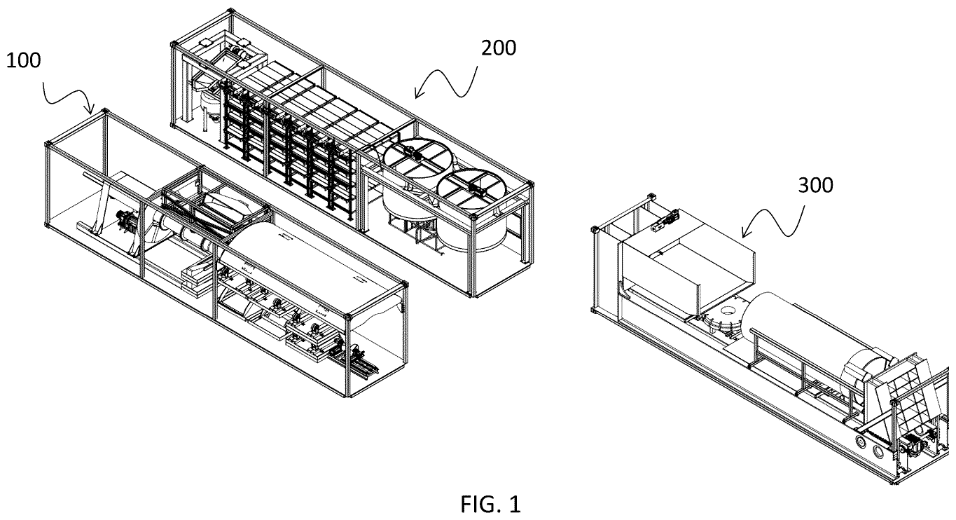

FIG. 1 illustrates a perspective view of pipe formation apparatus 100 in transportation configuration. The pipe formation apparatus 100 may produce resin fiber pipes. In some embodiments, pipe formation apparatus 100 fits, in a transportation configuration, in a standard ISO 668 intermodal container form. For example, a 1AAA 40 or 40 ft High Cube form factor includes a frame with external dimensions, 8 feet wide, 9.5 feet high, and 40 feet long (2.44 m by 2.90 m by 12.20 m). In some embodiments, the container form is a 1AA form factor or a 40 ft Container including a frame with external dimensions, 8 feet wide, 8.5 feet high, and 40 feet long (2.44 m by 2.60 m by 12.20 m). Also shown in FIG. 1 is a material stores container 200 holding one or more supplies or materials used in the construction of pipes. In some embodiments, material stores container 200 holds material such as filament or roving spools, mat, resin, and filler. The material stores container may be an intermodal container of a size the same or different used for pipe formation apparatus 100.

Also shown in FIG. 1 is a hydrostatic pressure test apparatus 300. In some embodiments, material stores container 200 or hydrostatic pressure test apparatus 300 has a transportation configuration that conforms to a standard ISO 668 intermodal container form which may be different in size to material stores container 200 or a container holding pipe formation apparatus 100.

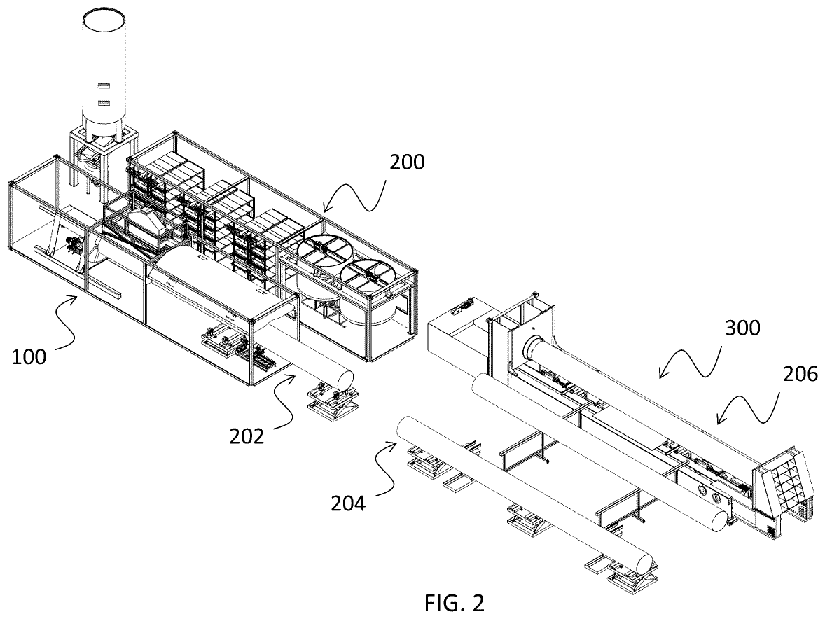

Turning to FIG. 2 which illustrates a perspective view of pipe formation apparatus 100, material stores container 200, and hydrostatic pressure test apparatus 300 each in a deployed configuration. The pipe formation apparatus 100 is configured to produce resin fiber pipes such as pipe 202, including fiber (e.g., filament, mat, or roving) wound around a mandrel and impregnated with resin and filler (e.g., sand). In operation, pipes manufactured at pipe formation apparatus 100 (e.g., pipe 204) may be transferred by a material handling system to hydrostatic pressure test apparatus 300—e.g., pipe under test 206. For example, the material handling system may include guides, jacks, lifts, rollers, saddles, stands, tables, turntables, and the like.

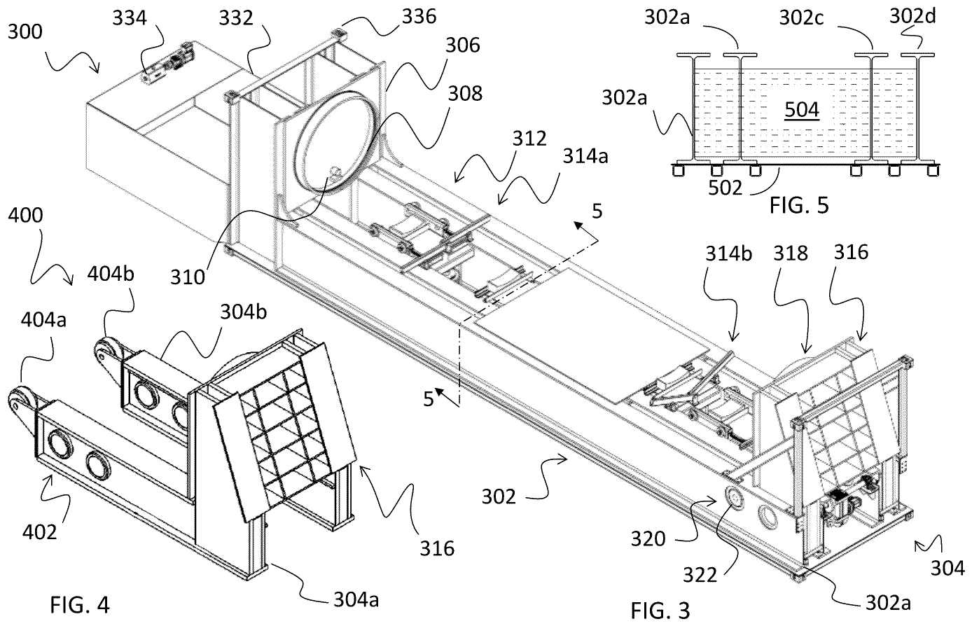

Turning to FIG. 3, which illustrates a perspective view of hydrostatic pressure test apparatus 300 including a first plurality of beams 302 disposed below the pipe under test, and a second plurality of beams spaced apart from the first plurality of beams 302 such that the first plurality of beams 302 and second plurality of beams 304 may move longitudinally relative to each other without interference.

Hydrostatic pressure test apparatus 300 includes a first upright member, conventionally called a headstock 306 is rigidly coupled to the first plurality of beams 302. In some embodiments, hydrostatic pressure test apparatus 300 includes a first seal 308 on the proximal side of headstock 306. The first seal 308 encloses an interior of space within which is an inlet 310.

Fluid may enter a pipe under test by inlet 310. In some embodiments, inlet 310 is located near the bottom of first seal 308, whereas in known test machines, the inlet is centered, requiring the pipe to be lifted to a higher position.

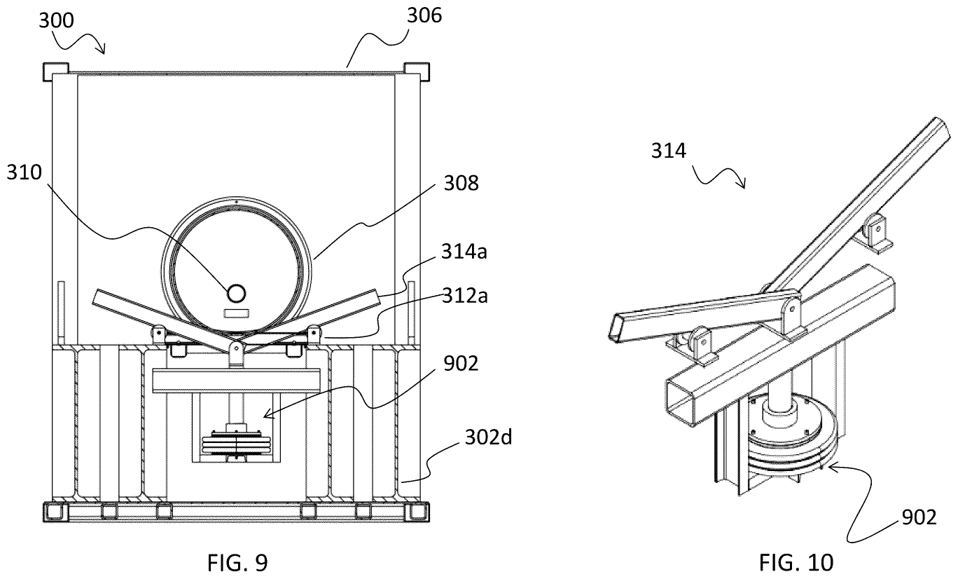

Pipes under test (e.g., pipe under test 206) may be supported by one or more bodies, such as saddle 312 overlying first plurality of beams 302. The saddle 312 may be one of one or more supports for pipe under test 206. In some embodiments, saddle 312 transfers several tons to first plurality of beams 302. In some embodiments, a pipe under test may be moved or supported by one or more lifts such as pneumatic lifts. For example, as shown, hydrostatic pressure test apparatus 300 includes a first lift 314a and a second lift 314b. These are further described herein in relation to, at least, FIG. 9 and FIG. 10.

Hydrostatic pressure test apparatus 300 includes a second upright member, conventionally called for clarity, a tailstock 316 rigidly coupled to the second plurality of beams 304 and a second seal 318 on the proximal side of tailstock 316 facing headstock 306. A person of skill in the art will appreciate that the terms head and tail provide clarity and could be reversed in other embodiments. In operation, hydrostatic pressure test apparatus 300 can hold a pipe under test between headstock 306 and tailstock 316. A pipe under test can be lifted into place to have a sealed engagement with first seal 308 or second seal 318.

In some embodiments, hydrostatic pressure test apparatus 300 includes a first plurality of holes 320 defined in first plurality of beams 302. At least one pin 322 engages the first plurality of holes 320 and couples first plurality of beams 302 to second plurality of beams 304 preventing relative motion of first plurality of beams 302 and second plurality of beams 304 along their respective shared principal axis.

In some embodiments, an actuator (not shown in FIG. 3) urges or moves at least one pin 322 fit into or out of a fit with at least one hole in the first plurality of holes 320. The at least one pin couples first plurality of beams 302 and second plurality of beams 304. For example, holds first plurality of beams 302 and second plurality of beams 304 in relative place when a pipe is tested. In some embodiments, the hydrostatic pressure test apparatus 300 includes four pins. For example, two on each side. In some embodiments, the at least one pin is moved by a jack, e.g., a hydraulic jack, a pneumatic jack, or a screw jack. In some embodiments, hydrostatic pressure test apparatus 300 includes a motor, pinion, and rack described further in FIG. 7.

Turning to FIG. 4 which illustrates a perspective view of tailstock frame 400 including second plurality of beams 304, and tailstock 316. The second plurality of beams 304 includes a second plurality of holes 402 to receive at least one pin 322. An actuator (as described in, at least, FIG. 3) urges or moves at least one pin 322 to move into or out of fit with second plurality of holes 402.

Second plurality of beams 304 includes beam 304a and beam 304b. In some embodiments, one or more of beam 304a or beam 304b includes a roller or caster at their distal end. For example, caster 404a and caster 404b.

FIG. 5 is a section view of the hydrostatic pressure test apparatus along section line 5-5′ shown in FIG. 3. As shown, first plurality of beams 302 are spaced apart in the lateral direction. Inferior to the first plurality of beams 302 (e.g., beam 302a, beam 302b, beam 302c, and beam 302d) is web 502 in sealed coupling with at least two beams in plurality of beams 302 (e.g., beam 302a, and beam 302d). Web 502, one or more beams in plurality of beams 302, and other bodies define a prism. And in some embodiments, web 502, one or more beams in plurality of beams 302 include one or more parts of a first reservoir, e.g., basin, container, pool, tank, or vessel, for fluid 504. The seams between web 502, one or more beams in plurality of beams 302, and other bodies, e.g., end web (not shown). For example, hold fluid 504 in a deployed configuration such as those shown in FIG. 2 and FIG. 3.

A person of ordinary skill in the art will appreciate the content of FIG. 5, the space or prism defined by web 502, one or more beams in plurality of beams 302 include one or more parts of a first reservoir reducing or eliminating the need for an external pool, such as, a large concrete water pool. Thus, hydrostatic pressure test apparatus 300 is mobile (e.g., portable), flexible, or useable.

Returning to FIG. 3. In some embodiments, hydrostatic pressure test apparatus 300 further includes a second reservoir 332, disposed outside of first plurality of beams 302 and in fluid communication with the first reservoir. In some embodiments, hydrostatic pressure test apparatus 300 includes a pump 334 to transfer fluid from the first reservoir (not shown in FIG. 3) or second reservoir 332 into a pipe under test.

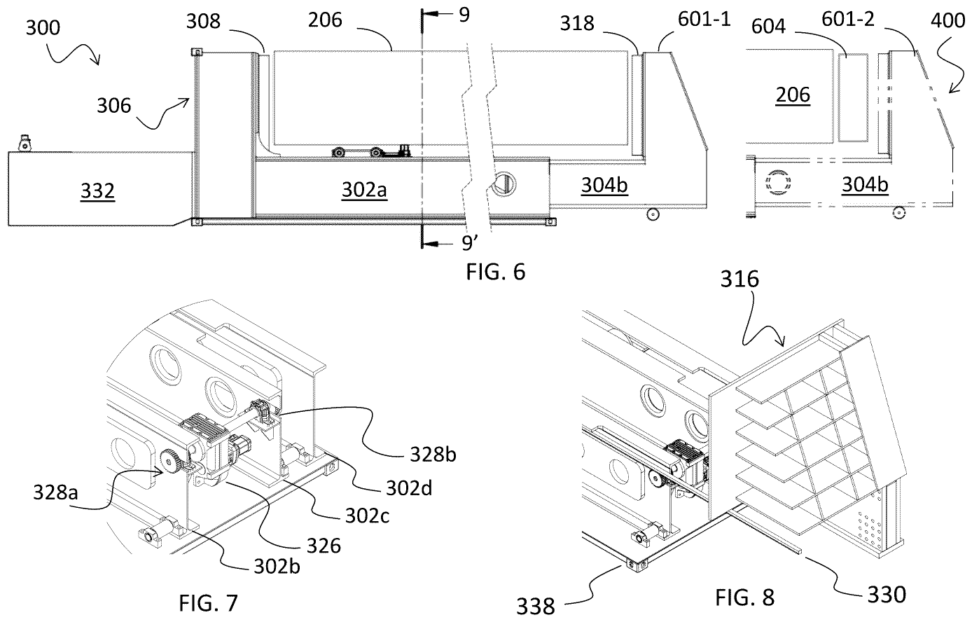

Turning to FIG. 6, which illustrates an elevation view of hydrostatic pressure test apparatus 300 and a pipe under test 206. In operation, hydrostatic pressure test apparatus 300 holds pipe under test 206 above first plurality of beams 302 or above first plurality of beams 302 and between headstock 306 and tailstock 316. Once pipe under test 206 is moved into place (e.g., lifted) first seal 308 or second seal 318 provide a fluid seal on pipe under test 206.

As shown in FIG. 6 tailstock frame 400 operates in a plurality of positions including a first position 601-1 and a second position 601-2. The movement from second position 601-2 to first position 601-1 to second position 601-2 provides a clamp on pipe under test 206. Readers will appreciate that despite being transported within a form factor of confined length, embodiments of hydrostatic pressure test apparatus 300 can test pipes of comparable length. For example, with a 12 m container, the hydrostatic pressure test apparatus 300 has a telescopic beam system including first plurality of beams 302 and second plurality of beams 304 that accommodate pipes up to about 12 meters in length.

In some embodiments, the pipe under test 206 includes a bell end (not shown). A coupler 604 may be placed between flared or bell end and the headstock 306 or tailstock 316. In some implementations, coupler 604 is made from a cut section of pipe.

Turning to FIG. 7 which illustrates in perspective view a first end of hydrostatic pressure test apparatus 300, and in particular, the near end as shown in FIG. 3. As shown, hydrostatic pressure test apparatus 300 includes first plurality of beams 302, such as beam 302b, beam 302c, and beam 302d. In some embodiments, hydrostatic pressure test apparatus 300 includes a motor 326 coupled to the first plurality of beams 302 and driving one or more pinions, e.g., pinion 328a, and pinion 328b.

Turning to FIG. 8 which illustrates in perspective and cutaway view, the first end of hydrostatic pressure test apparatus 300 and tailstock frame 400. The one or more pinions 328 engage one or more racks 330 coupled to tailstock frame 400. The motor 326 drives one or more pinions 328, one or more racks 330, and tailstock frame 400. Thus, in response to instructions, such as processor executable instructions motor 326 position tailstock frame 400 and headstock 306 in relative position for a pipe under test. In some embodiments, a plurality of pins (e.g. pins 322) provides a clamping force for a pipe under test. In some embodiments, motor 326 drives one or more pinions 328 engaged with one or more racks 330 to move tailstock 316. The action of the motor can be controlled by contact switches. For example, once the holes in first plurality of beams 302 are aligned with holes in second plurality of beams 304.

In some embodiments, when the pipe under test is squared between the two sealing points, the motor stops by a microswitch. Pins 322 are aligned with the holes and inserted an actuator such as a hydraulic jack. The engage pins lock in place tailstock frame 400, headstock 306, and the pipe under test. The pipe is then filled with water until the target pressure is reached (e.g., 32 bars, generating an internal force of 380 tons on both the headstock and tailstock). The pins 322 are designed to securely hold this pressure, as only they can withstand this level of force.

Turning to FIG. 8 hydrostatic pressure test apparatus 300 includes one or more mounts such as superior mount 336 and inferior mount 338. In some embodiments, at least one mount, e.g., inferior mount 338 is a corner casting as defined in ISO 1161 and may receive a twist lock. In some embodiments, headstock 306 is incorporated into the body separating an inferior and superior mount. The one or more mounts may be used in a transport configuration like shown in FIG. 1 or a deployed configuration shown in FIG. 2.

FIG. 9 is a section view of the hydrostatic pressure test apparatus from section line 9-9′ shown in FIG. 6. Hydrostatic pressure test apparatus 300 includes a headstock 306 rigidly coupled to the first plurality of beams 302. In some embodiments, hydrostatic pressure test apparatus 300 includes a first seal 308 on the proximal side of headstock 306. The first seal 308 encloses an interior of space within which is an inlet 310. Fluid may enter a pipe under test by inlet 310. In some embodiments, hydrostatic pressure test apparatus 300 includes a plurality of stops coupled to headstock 306, which in operation receive a pipe under test. In some embodiments, the plurality of stops has a wedge or frustoconical profile.

In some embodiments, hydrostatic pressure test apparatus 300 includes a first saddle 312a overlying first plurality of beams 302 and supporting a pipe under test (e.g., pipe under test 206). In some embodiments, a pipe under test may be supported by one or more lifts, such as, first lift 314a. In some poses the pipe under test is supported by one or more saddles such as saddle 312.

In some embodiments, first lift 314a is driven by a pneumatic actuator 902. Applicant appreciates that their choice of pneumatic lift 914, including a pneumatic actuator 902, helps make the hydrostatic pressure test apparatus 300 (and indeed the entire manufacturing system) more mobile and sustainable versus a hydraulic system where leaks (e.g., of hydraulic fluid like mineral or synthetic oil) would contaminate the fluid (e.g., water) in the pipe under test. See, for example, fluid 504 in FIG. 5.

As can be appreciated in FIG. 9 and FIG. 10, in operation pneumatic lift 914 in response to air pressure provided or mediated by pneumatic actuator 902 moves the pipe under test. The pneumatic lift 914 lifts (e.g., raises, lowers, or supports) the pipe under test—e.g., before, during, testing. During testing the pipe under test and fluid within are supported by one or more bodies such as saddle 312. When filled, a ten meter length of 1000 mm pipe weighs almost eight tons and a pipe of 12 meters and 1500 mm is almost twenty-one tons of water. The plurality of beams 302 may be of a length to handle 12 meter pipes.

In some embodiments, pneumatic actuator 902 rigidly coupled to first plurality of beams 302 and supports pneumatic lift 914. The pneumatic lift 914 may include pivotable couplings to one or more arms and thus accommodate different sizes of pipes. The arms may form a T with vertical parts of pneumatic lift 914 which is useful to roll pipe under test 206. As shown in FIG. 9 or FIG. 10, the arms may form a Y with vertical of pneumatic lift 914 which is useful to prevent roll of pipe under test 206 or park pipe under test 206 in a saddle such as saddle 912. Pneumatic lift 914 may bring the pipe under test into position to be held by saddle 312. In some embodiments, in this position the pipe under test mates with seal first 308 and second seal 318. In a retracted state pneumatic lift 914 allows for the pipe under test (e.g., pipe under test 206) to be moved in or out of hydrostatic pressure test apparatus 300. The Applicant appreciates there are unique ways to hydrostatic pressure test apparatus 300.

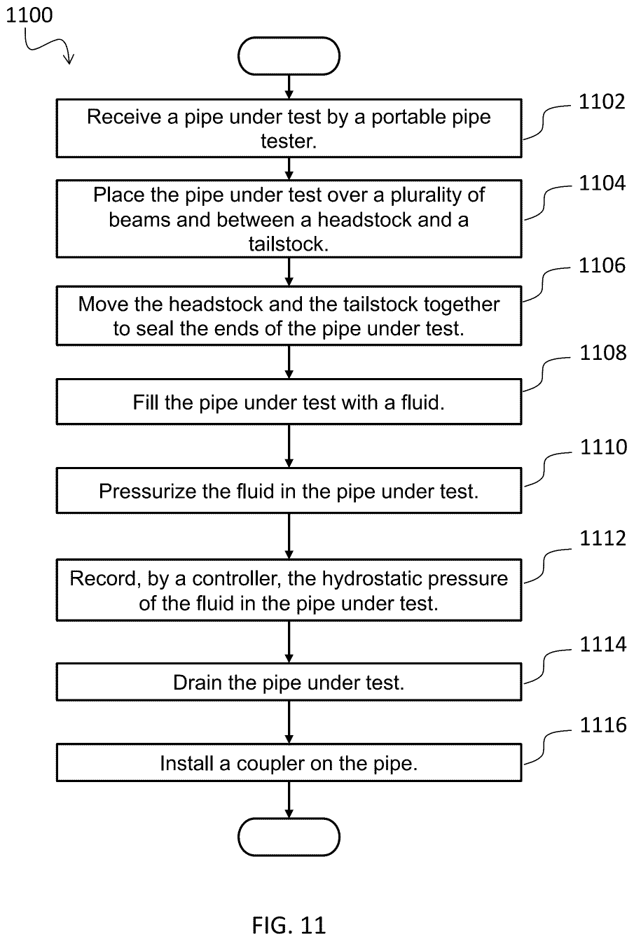

FIG. 11 illustrates a flow diagram of a method of operation of a hydrostatic pressure test apparatus also called a pipe tester. In particular, FIG. 11 shows method 1100 executable by one or more operators of a mobile pipe tester (e.g., hydrostatic pressure test apparatus 300). The mobile pipe tester may be communicatively coupled, such as by circuitry, to a controller such as at least one hardware processor, for the operation, or improvement in the operation, of the hydrostatic pressure test apparatus. One or more parts of method 1100 may be performed by the controller. For method 1100 as with other methods disclosed herein, a person skilled in the art will appreciate that other acts may be included, removed, and/or varied or performed in a different order to accommodate alternative implementations.

At 1102, the operators receive a pipe under test by a mobile pipe tester. In some embodiments, the operators receive the pipe under test (e.g., pipe under test 206) on a saddle (e.g., saddle 312) supported by the plurality of beams (e.g., first plurality of beams 302).

At 1104, the operators, place the pipe under test over a plurality of beams and between a headstock and a tailstock. In some embodiments, the mobile pipe tester further includes a pneumatic lift coupled to the plurality of beams, and placing the pipe under test over a plurality of beams further consists of, in response to adjusting the pressure in the pneumatic lift, changing the height of the pipe under test. In some embodiments, the pipe under test simply sits on saddle 312 and is centered and squared for testing. In some embodiments, adjusting pressure in the pneumatic lift (e.g., lift 314) is done in response to executing processor-executable instructions. In some embodiments, the mobile pipe tester further includes a plurality of saddles overlying a frame and underlying the pipe under test. The pneumatic lift, in response to adjusting pressure in the pneumatic lift, brings the pipe under test to rest on one or more saddles in the plurality of saddles, or lifts the pipe under test from one or more saddles in the plurality of saddles.

At 1104, in some implementations, the mobile pipe tester includes a lift including two positions: UP and DOWN. The UP position is designated for moving a pipe under test and the DOWN position brings the pipe under test to rest in one or more saddles. The up position may correspond to the T shape and the down position to the Y shape described above for lift 914. The use of an UP and DOWN position eliminates the need for manual adjustment of pipe elevation, reducing the risk of pipe damage and saving time.

At 1106, the operators move the headstock and the tailstock together (e.g., towards each other) and, in response, the headstock and the tailstock seal the ends of the pipe under test. For example, the operators direct the controller to execute processor executable instructions, which, when executed, cause the tailstock (e.g., tailstock 316) to move toward the headstock. For example, the operators use motor 326 to drive pinion(s) 328 engaged with rack(s) 330 coupled to tailstock frame 400. In response to motivating motor 326, the tailstock frame 400, and tailstock 316 are driven toward headstock 306 and clamp the pipe under test. In some implementations, headstock 306 is fixed to first plurality of tension beams 302 and a rack and pinion moves tailstock 316 to moved towards headstock 306. In some implementations, the operators or the controller activates a motor to drive a rack and pinion that pushes the tailstock against the pipe under test and clamps the pipe under test between the headstock and the tailstock.

In some implementations, at 1106 a motor coupled to the rack and pinion moves tailstock 316, pushing a pipe under test into a sealed position. When the pipe under test is squared between the two sealing points, the motor stops by a microswitch once the at least one pin are aligned with the holes in the first plurality of beams 302 and the second plurality of beams 304. In some embodiments, the at least one pin are moved by a jack, e.g., hydraulic jack, pneumatic jack, or screw jack. For example, the jack pushes a pin in pins 322 into a first hole in beam 302a and hole 402 in beam 304a. Once repeated for a plurality of pins beams 302 and beam 304 are held in relative position. The pipe is then filled with a fluid such as water. For example, at 32 bars there is an internal force of 380 tons on both headstock 306 and tailstock 316. The at least one pin 322 holds against the internal tension force provided by the fluid.

In some implementations, at 1106 a coupler is placed on the pipe under test on a first end between the headstock 306 or tailstock 316. For example, at 1106, tailstock 316 is moved to a predetermined distance from the end of the pipe under test. A coupler, such as coupler 604, is added and tailstock 316 is moved again to seal the pipe under test. In some implementations, after method 1100, coupler 604 is placed on the pipe at 1106 removing the need for a separate machine to install coupler 604. In some implementations, after method 1100, coupler 604 is placed on the pipe.

At 1108, the operators fill the pipe under test with a fluid. For example, fluid 504, such as water. In some embodiments, the mobile pipe tester further includes a reservoir and a filter in fluid communication with the reservoir. At 1108 the operators may filter the fluid. In some embodiments, the operators transfer the fluid between the reservoir and the pipe under test. For example, fill the pipe under test from the reservoir.

At 1110, the operators pressurize the fluid in the pipe under test (e.g., pipe under test 206). The operators may run pump 334. In some implementations, a first pump provides fluid at a high volume, but low pressure, and a second pump provides fluid at higher pressure, e.g., up to 64 MPa. The pressure in the fluid under test varies with embodiments and specifications of the pipe. In some implementations, the pressure is two (2) times atmospheric pressure. In some implementations, the pressure is a multiple of the intended max working normal pressure of the pipe. For example, twice the normal pressure of the pipe. For a 1000 mm pipe with a 16 bar normal pressure, the test pressure is 32 bar or 32 MPa.

At 1112, the controller records the hydrostatic pressure of the fluid in the pipe under test. Data logging of site-built pipes provides quality assurance. In some embodiments, the controller displays a plurality of values of the hydrostatic pressure in the pipe under test over time. For example, five minutes.

At 1114, the operators drain the pipe under test. For example, the fluid in the pipe under test is transferred to a reservoir.

At 1116, in some implementations after 1114, a coupler 604 is placed or installed on the pipe. In some implementations, coupler 604 is placed on a first end of the pipe. Method 1100 ends until invoked again.

1. A portable hydrostatic pressure test device for use with a pipe, the device comprising:
a first plurality of tension beams placed in parallel to each other, wherein:
each of the first plurality of tension beams has a first end and a second end, and
the first plurality of tension beams in operation are below the pipe;
a second plurality of tension beams, wherein, in operation, the second plurality of tension beams are between a respective pair of the first plurality of tension beams, and are in sliding engagement with the first plurality of tension beams;
a headstock coupled to the first plurality of tension beams nearer the first end;
a first seal coupled to the headstock including a first outer periphery, and which in operation faces the second end of the first plurality of tension beams;
a tailstock coupled to the second plurality of tension beams;
a second seal coupled to the tailstock including a second outer periphery, and which in operation faces the first end of the first plurality of tension beams; and
an inlet coupled to the headstock or the tailstock and disposed proximally of the first outer periphery or the second outer periphery.

2. The device of claim 1 further comprising:
a first pin;
a first plurality of holes defined in the first plurality of tension beams in a transverse orientation; and
a second plurality of holes defined in the second plurality of tension beams in a transverse orientation.

3. The device of claim 2, wherein the first pin engages the first plurality of holes and the second plurality of holes.

4. The device of claim 2 further comprising a jack coupled to the first pin and in operation motivates the first in and out of engagement with the first plurality of holes and the second plurality of holes.

5. The device of claim 1 further comprising a reservoir incorporated into the plurality of beams.

6. The device of claim 5 further comprising a web of material enclosing one or more sides of a prism of space of the plurality of tension beams to form the reservoir.

7. The device of claim 1 further comprising a filter in fluid connection with the inlet.

8. The device of claim 1, further comprising one or more clamps between the headstock and the tailstock.

9. The device of claim 1 further comprising a pneumatic lift which in response to air pressure moves the pipe under test.

10. The device of claim 1 further comprising a saddle overlying a part of the frame and underlying the pipe under test, which in operation supports the mass of the pipe under test and any fluid therein.

11. The device of claim 1 further comprising a rack and pinion coupled to the first plurality of beams and the tailstock, and in operation moves the tailstock in the longitudinal direction.

12. The device of claim 1, wherein the first seal and the second seal are one of flange, pipe cap, and seal plate.

13. A method for testing hydrostatic pressure in a pipe under test by a portable pipe tester including a headstock, a tailstock, and a controller, wherein the method comprises:
placing the pipe under test over a plurality of beams and between the headstock and the tailstock;
in response to moving the headstock and the tailstock together, sealing the ends of the pipe under test;
filling the pipe under test with a fluid;
pressurizing the fluid in the pipe under test; and
recording, by the controller, the hydrostatic pressure of the pipe under test.

14. The method of claim 13 further comprising receiving the pipe under test on a saddle supported by the plurality of beams.

15. The method of claim 13, wherein the portable pipe tester further includes a pneumatic lift coupled to the plurality of beams, and placing the pipe under test over a plurality of beams further comprises, in response to adjusting pressure in the pneumatic lift, adjusting the height of the pipe under test.

16. The method of claim 13, wherein moving the headstock and the tailstock together further comprises:
pushing the tailstock, by a rack and pinion, against the pipe under test, and
clamping the pipe under test between the headstock and the tailstock.

17. The method of claim 13 further comprising displaying a plurality of values of hydrostatic pressure in the pipe under test over time.

18. The method of claim 13, wherein the portable pipe tester further comprises a reservoir and a filter in fluid communication with the reservoir, the method further comprising:
filtering the fluid; and
transferring the fluid between the reservoir and the pipe under test.
